(19) United States
(12) Patent Application Publication
(10) Pub. No.: US 2016/0342013 A1
(43) Pub. Date: Nov. 24, 2016

(54) Frame Structure for a Liquid Crystal Display

(71) Applicant: Shenzhen China Star Optoelectronics Technology Co., Ltd., Shenzhen, Guangdong (CN)

(72) Inventor: Gege ZHOU, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/425,005

(22) PCT Filed: Jan. 4, 2015
(86) PCT No.: PCT/CN2015/070070

§ 371 Date: Feb. 28, 2015

(30) Foreign Application Priority Data
Dec. 10, 2014 (CN) 201410758880.9

(51) Int. Cl. G02F 1/1333; G02F 1/1335

(52) U.S. Cl. CPC G02F 1/133308; G02F 1/133504; G02F 2001/133331; G02F 2202/28

(57) ABSTRACT

The disclosure is related to a frame structure for a liquid crystal display, comprising: a backplane; a frame overlapping on the backplane; a liquid crystal panel disposed in the frame; and a cover plate covering the liquid crystal panel; wherein the cover plate is provided with a transparent structure locating on both sides of the cover plate and above on the frame. The improvement of the disclosure is replacing the conventional cover plate of liquid crystal panel by the cover plate with a transparent structure, thereby increasing the area of display region and aesthetics of the electronic product.

### BACKGROUND

1. Technical Field

The disclosure is related to the field of the liquid crystal display (LCD) device of an electronic apparatus, and more particular to a frame structure for the liquid crystal display.

2. Related Art

In modern life, a wide range of electronic apparatus, such as LCD TV, LCD PCs, tablet PCs and touch-screen phones, are available for more and more families. When people choose an electronic apparatus, among the electronic products with different brands having the same functionality, people tend to pay more attention to the energy-saving property and the aesthetics. So electronic products with narrow frames attract more and more people's attention.

In order to achieve a narrow frame structure for conventional liquid crystal display devices, the LCD panel and the frame are designed as a whole. When the screen is not lighted up, the black border almost integrates as a body with the black color of the LCD panel. Thus users hardly discover the frame. However, when the LCD panel is lighted up, the frame width of about 1 cm appears. Besides, the packaging of electronic products needs to ensure complete sealing of the liquid crystal panel, and furthermore the backlight module needs the focal point. If the frames of the electronics products frame are too thin, the liquid crystal panel cannot be tightly fixed because of its property of fragility. Thus the electronic products cannot be designed truly frameless.

### SUMMARY

The technical problem the disclosure intends to solve is to provide a frame structure for the liquid crystal display. By way of configuring a prism structure on the cover plate of the liquid crystal panel, the narrow frame structure may be achieved for the electronic products either in turn-on or turn-off circumstance, to increase the display area of the liquid crystal panel.

In order to achieve the above object, the disclosure adopts the following technical solutions.

A frame structure for a liquid crystal display, comprises: a backplane; a frame overlapping on the backplane; a liquid crystal panel disposed in the frame; and a cover plate covering the liquid crystal panel; wherein the cover plate is provided with a transparent structure locating on both sides of the cover plate and above the frame.

In one embodiment, the transparent structure and the cover plate constitute a one-piece structure.

In one embodiment, the cover plate is provided with a top surface and a bottom surface. The transparent structure connects with the arc surfaces of the top surface and the bottom surface.

In one embodiment, the cross-section of the arc surface is a sector shape.

In one embodiment, the cover plate and the transparent structure are removable structure; the transparent structure comprises a second light-emitting surface and an inner wall, and the cover plate comprises a first light-emitting surface and an outer wall.

In one embodiment, the second light-emitting surface is an inclined plane.

In one embodiment, the second light-emitting surface is an arc surface.

In one embodiment, the first light-emitting surface connecting with the second light-emitting surface; a transparent adhesive is disposed between the inner wall and the outer wall.

In one embodiment, the transparent structure is a prism.

In one embodiment, an optical adhesive is disposed between the cover plate and the liquid crystal panel, and between the transparent structure and the frame.

Beneficial effects of the disclosure:

The disclosure provides a frame structure for a liquid crystal display, to improve the conventional LCD cover plate to have a light-transmitting structure, to achieve the light emitting from both sides of the cover plate for the LCD panels. An image displayed by the LCD panel may be seen from the two sides of the cover plate, so that people hardly perceive the panel frame when the electronic products are in use. The electronic products thus have wider display screens. The disclosure also increases both the aesthetics and usefulness of the electronic products.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 illustrates the enlarged view of the frame structure for the liquid crystal display according to first embodiment of the present disclosure;

FIG. 2 illustrates the enlarged view of the frame structure for the liquid crystal display according to second embodiment of the present disclosure; and

FIG. 3 illustrates the enlarged view of the frame structure for the liquid crystal display according to third embodiment of the present disclosure.

### DETAILED DESCRIPTION

To illustrate the technical features and the structure of the disclosure in a better way, the following description with reference to the accompanying drawings is provided to explain the exemplary embodiments of the disclosure.

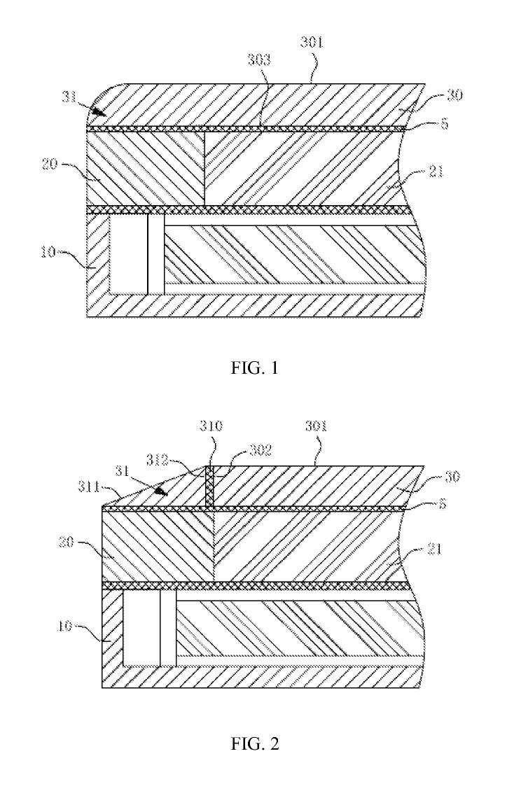

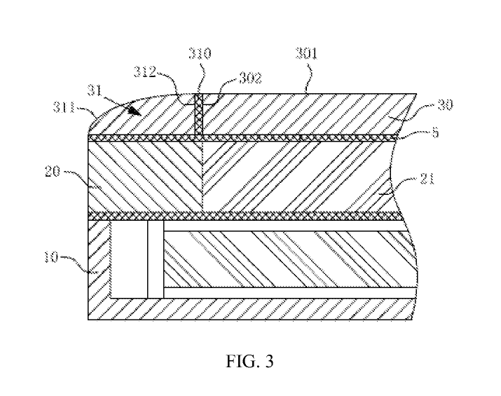

Refer to FIG. 1, FIG. 2 and FIG. 3, a frame structure for a liquid crystal display, comprises a backplane 10, a liquid crystal panel 21, a frame 20 and a cover plate 30. The liquid crystal panel 21 is disposed in the frame 20. The frame 20 overlaps on the backplane 10. The backplane 10 is disposed under the frame 20 and the liquid crustal panel 21 for placing the plastic frame, the reflection sheet, the light guide and the optical films etc. The cover plate 30 covers the liquid crystal panel 21 in order to protect the liquid crustal panel 21 and the image produced from the liquid crystal panel 21. The cover plate 30 is provided with a transparent structure 31 locating on both sides of the cover plate 30 and above the frame 20. The transparent structure 31 overlaps on the frame 20. The transparent structure 31 of the embodiment is disposed at the left and right sides of the cover plate 30. The cover plate 30 and the transparent structure 31 are located on the same plane. The frame 20 and the liquid crystal panel 21 are located on the same plane. An optical adhesive 5 is disposed between the cover plate 30 and the liquid crystal panel 21, and between the transparent structure 31 and the frame 20. The optical adhesive 5 transmits the light for display of the liquid crystal panel 21 such that the image displayed from the liquid crystal panel 21 may be shown on the cover plate 30 and the transparent structure 31.

### Embodiment 1

As shown in FIG. 1, the transparent structure 31 and the cover plate 30 constitute a one-piece structure in the embodiment. The frame 20 supports the transparent structure 31 and cover plate 30. The transparent structure 31 is disposed above the frame 20. The cover plate 30 comprises a first light-emitting surface 301 and a bottom surface 303. The transparent structure 31 is an arc surface which connects the first light-emitting surface 301 and the bottom surface 303. The cross-section of the acr surface is a sector shape. In particular, the arc surface of the transparent structure 31 reflects the light for display emitting from the liquid crystal panel 21. With respect to the area of the conventional cover plate 30 for displaying the light of the liquid crystal panel 21, the one-piece structure which is constituted by the transparent structure 31 and the cover plate 30 has a gareter display area. In the displaying mode, the light for display refracted by the transparent structure 31 obscures the color of the frame 20, so that the frame 20 is imperceptible by people when the electrical product is in use. The aesthetics of the electronic products increases. Further, in the case of electronic products turned off, the color of the frame 20 is the same as that of the liquid crystal panel 21. The color of the two structures is almost the same, so that the user is hardly to discover the frame 20, to achieve the narrow frame design on the electronic products in turn-on and turn-off condition.

### Embodiment 2

As shown in FIG. 2, the cover plate 30 and the transparent structure 31 are removable structure in this embodiment. The transparent structure 31 comprises a second light-emitting surface 311 and an inner wall 312, and the cover plate 30 comprises a first light-emitting surface 301 and an outer wall 302. The first light-emitting surface 301 connects with the second light-emitting surface 311 to form a display screen for an electronic device. The second light-emitting surface 311 is an inclined plane so that the cross-section of the transparent structure 31 is a triangular shape. The transparent structure 31 is a prism. Further, a transparent adhesive 310 is disposed between the inner wall 312 and the outer wall 302 in order to make the transparent structure 31 and the cover plate 30 fit closely without affecting the liquid crystal panel 21 to emit the light for display. Thus a removable structure is thereby formed.

Specifically, the transparent structure 31 is designed as a prism to achieve a better effect of light-transmissive refraction on both sides of the cover plate 30. With respect to the area of the conventional cover plate 30 for displaying the light of the liquid crystal panel 21, the triangular prism structure has a gareter display area. The liquid crystal panel 21 not only emits the light for display perpendicular to the cover plate 30 but also emits the light for display towards the second light-emitting surface 311 after the light is refracted by the triangular prism, thereby increasing the light emitting area of the screen of the electronic product. In the displaying mode, the display light refracted by the transparent structure 31 allows the user to observe the light of the displayed image of the liquid crystal panel 21 at the transparent structure 31 on both sides of the cover plate 20. The light for display obscures the color and the shape of the frame 20, so that the frame 20 is imperceptible by people when the electrical product is in use. The aesthetics of the electronic products increases. Further, in the case of the electronic product turned off, the color of the frame 20 is the same as that of the liquid crystal panel 21. The color of the two structures is almost the same, so that the user is hardly to discover the frame 20, to achieve the narrow frame design on the electronic products in turn-on and turn-off condition.

### Embodiment 3

As shown in FIG. 3, the transparent structure 31 and the cover plate 30 are removable structure in this embodiment. The transparent structure 31 comprises a second light-emitting surface 311 and an inner wall 312, and the cover plate 30 at least comprises a first light-emitting surface 301 and an outer wall 302. The first light-emitting surface 301 connects with the second light-emitting surface 311 to form a display screen for an electronic device. The second light-emitting surface 311 is an acr surface such that the cross-section of the transparent structure 31 is a sector shape. The transparent structure 31 is a prism. Further, a transparent adhesive 310 is disposed between the inner wall 312 and the outer wall 302 in order to make the transparent structure 31 and the cover plate 30 fit closely without affecting the liquid crystal panel 21 to emit the light. Thus a removable structure is thereby formed.

Specifically, the transparent structure 31 is designed as a quarter-circle shape or a quarter-ellipse shape to achieve better imaging on the both sides of the cover plate 30. With respect to the area of the conventional cover plate 30 for displaying the light of the liquid crystal panel 21, the quarter-circle or the quarter-ellipse structure has a gareter display area. The liquid crystal panel 21 not only emits the display light perpendicular to the cover plate 30, but also emits the light for display towards the sector arc after the light is refracted by the sector-shaped prism. The sector arc facilitates increasing the light emitting area of the screen of the electronic product, and enhancing the user's visual experience. In the displaying mode, the display light refracted by the transparent structure 31 allows the user to observe the light of the displayed image of the liquid crystal display light for display obscures the color and the shape of the frame 20, so that the frame 20 is imperceptible by people when the electrical product is in use. The aesthetics of the electronic products increases. Further, in the case of the electronic product turned off, the color of the frame 20 is the same as that of the liquid crystal panel 21. The color of the two structures is almost the same, so that the user is hardly to discover the frame 20, to achieve the narrow frame design on the electronic products in turn-on and turn-off condition.

The disclosure provides a frame structure for a liquid crystal display, to improve the conventional LCD cover plate to have a light-transmitting structure, to achieve the light emitting of LCD panel from both sides of the cover plate. An image displayed by the LCD panel may be seen from the two sides of the cover plate, so that people hardly perceive the panel frame when the electronic products are in use. The electronic products thus have wider display screens. The disclosure also increases both the aesthetics and usefulness of the electronic products.

The above embodiments of the disclosure are only for clearly explaining the disclosure, and it does not intend to limit the disclosure. For those skilled in the art, other variations and modifications may be made on the above basis. It is not necessary to provide all the embodiments herein. Any modifications, equivalent substitution, and improvement should be regarded as within the protection scope of the disclosure as defined by the appended claims.

What is claimed is:

1. A frame structure for a liquid crystal display, comprising:
a backplane;
a frame overlapping on the backplane;
a liquid crystal panel disposed in the frame; and
a cover plate covering the liquid crystal panel;
wherein the cover plate is provided with a transparent structure locating on both sides of the cover plate and above on the frame.

2. The frame structure for the liquid crystal display according to claim 1, wherein the transparent structure and the cover plate constitute a one-piece structure.

3. The frame structure for the liquid crystal display according to claim 2, wherein the cover plate comprises a first light-emitting surface and a bottom surface, the transparent structure is an arc surface which connects the first light-emitting surface and the bottom surface.

4. The frame structure for the liquid crystal display according to claim 3, wherein the cross-section of the arc surface is a sector shape.

5. The frame structure for the liquid crystal display according to claim 1, wherein the cover plate and the transparent structure are removable structure; the transparent structure comprises a second light-emitting surface and an inner wall, and the cover plate comprises a first light-emitting surface and outer wall.

6. The frame structure for the liquid crystal display according to claim 5, wherein the second light-emitting surface is an inclined plane.

7. The frame structure for the liquid crystal display according to claim 6, wherein the first light-emitting surface connects with the second light-emitting surface; a transparent adhesive is disposed between the inner wall and the outer wall.

8. The frame structure for the liquid crystal display according to claim 7, wherein the transparent structure is a prism.

9. The frame structure for the liquid crystal display according to claim 5, wherein the second light-emitting surface is an arc surface.

10. The frame structure for the liquid crystal display according to claim 9, wherein the first light-emitting surface connecting with the second light-emitting surface; a transparent adhesive is disposed between the inner wall and the outer wall.

11. The frame structure for the liquid crystal display according to claim 1, wherein an optical adhesive is disposed between the cover plate and the liquid crystal panel, and between the transparent structure and the frame.
